(19) United States
(12) Patent Application Publication
(10) Pub. No.: US 2013/0185012 A1
(43) Pub. Date: Jul. 18, 2013

(54) CIRCUIT, APPARATUS, AND METHOD FOR SENSOR OUTPUT CORRECTION AND SEQUENCE CONTROL

(71) Applicants: Konosuke YAMAMOTO, Tokyo (JP); Yoichi KIMURA, Tokyo (JP)

(72) Inventors: Konosuke YAMAMOTO, Tokyo (JP); Yoichi KIMURA, Tokyo (JP)

(21) Appl. No.: 13/727,921

(22) Filed: Dec. 27, 2012

(30) Foreign Application Priority Data
Jan. 12, 2012 (JP) 2012-003765

(51) Int. Cl. G06F 17/00; G05B 11/01

(52) U.S. Cl. CPC G06F 17/00; G05B 11/01
USPC 702/104; 700/23

(57) ABSTRACT

A sensor output correction circuit includes a storage unit configured to rewritably store one or more commands for correcting a sensor output from a sensor, a reading unit configured to read a target command from the one or more commands stored in the storage part, plural execution units, each of the plural execution units configured to execute a sequence corresponding to the one or more commands, and a selecting unit configured to select a target execution unit from the plural execution units, the target execution unit configured to execute a target sequence corresponding to the target command read by the reading unit. When execution of the target sequence is completed, an address accessed by the reading unit at a time of reading the target command is shifted to another address.

### BACKGROUND OF THE INVENTION

1. Field of the Invention

The present invention generally relates to a circuit, apparatus, and method for sensor output correction and sequence control, for example, a sensor output correction circuit, a sensor output correction apparatus, a sequence control circuit, and a sequence control method for executing a sequence corresponding to a command.

2. Description of the Related Art

FIG. 1 is a schematic diagram illustrating a sensor output correction apparatus 160 according to a related art example. The sensor output correction apparatus 160 includes a pressure sensor 150 and a sensor output correction circuit 130 for correcting sensor output from the pressure sensor via a preamp 121. The sensor output correction circuit 130 includes a ΔΣ modulator 115 and a digital filter 113. The ΔΣ modulator 115 and the digital filter 113 serve as an AD (analog/digital) converter part for converting analog values into digital values. The analog values correspond to, for example, sensor outputs supplied from the pressure sensor 150 or a temperature sensor 117 via a multiplexer 116. The sensor output correction circuit 130 also includes an EEPROM (Electrically Erasable Programmable Read-Only Memory) 101 serving as a non-volatile memory that stores calibration data for correcting variability (inconsistency) of sensor outputs of the pressure sensor.

A host device 140 reads out calibration data stored in the EEPROM 101 via a communication interface circuit 102 (e.g., Serial Peripheral Interface (SPI)) and performs operation for correcting AD converted values of the sensor outputs of the pressure sensor 150 by using the calibration data read out from the EEPROM 101. Further, the host device 140 also control operations of a switch 118 for switching, for example, the start/end of the AD conversion process or the enable/disable of the pressure sensor 150 and the temperature sensor 117.

As for a related art document of the sensor output correction circuit, there is, for example, Japanese Laid-Open Publication No. 2009-156658.

However, with the related art example illustrated in FIG. 1, the workload of the host device 140 is large because the host device 140 needs to control all of the processes of the sensor output correction circuit 160.

### SUMMARY OF THE INVENTION

The present invention may provide a sensor output correction circuit, a sensor output correction apparatus, a sequence control circuit, and a sequence control method that substantially obviates one or more of the problems caused by the limitations and disadvantages of the related art.

Features and advantages of the present invention will be set forth in the description which follows, and in part will become apparent from the description and the accompanying drawings, or may be learned by practice of the invention according to the teachings provided in the description. Objects as well as other features and advantages of the present invention will be realized and attained by a sensor output correction circuit, a sensor output correction apparatus, a sequence control circuit, and a sequence control method particularly pointed out in the specification in such full, clear, concise, and exact terms as to enable a person having ordinary skill in the art to practice the invention.

To achieve these and other advantages and in accordance with the purpose of the invention, as embodied and broadly described herein, an embodiment of the present invention provides a sensor output correction circuit including a storage unit configured to rewritably store one or more commands for correcting a sensor output from a sensor, a reading unit configured to read a target command from the one or more commands stored in the storage part, plural execution units, each of the plural execution units configured to execute a sequence corresponding to the one or more commands, and a selecting unit configured to select a target execution unit from the plurality of execution units, the target execution unit configured to execute a target sequence corresponding to the target command read by the reading unit, wherein when execution of the target sequence is completed, an address accessed by the reading unit at a time of reading the target command is shifted to another address.

Other objects and further features of the present invention will be apparent from the following detailed description when read in conjunction with the accompanying drawings.

### BRIEF DESCRIPTION OF THE DRAWINGS

FIG. 1 is a schematic diagram illustrating a sensor output correction apparatus according to a related art example;

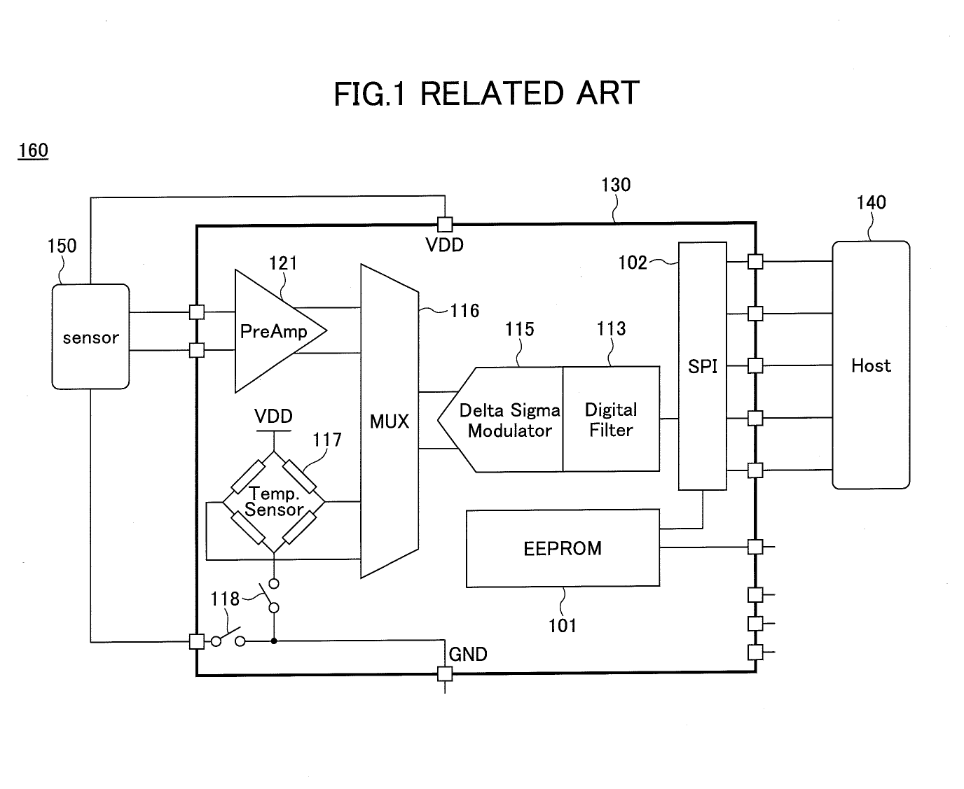

FIG. 2 is a schematic diagram illustrating a configuration of a sensor output correction apparatus according to an embodiment of the present invention;

FIG. 3 is a sequence diagram illustrating processes of a sensor output correction apparatus;

FIG. 4 is a schematic diagram illustrating a configuration of a sequencer according to an embodiment of the present invention; and

FIG. 5 is an example of a state chart of a sequencer according to an embodiment of the present invention.

### DESCRIPTION OF THE PREFERRED EMBODIMENTS

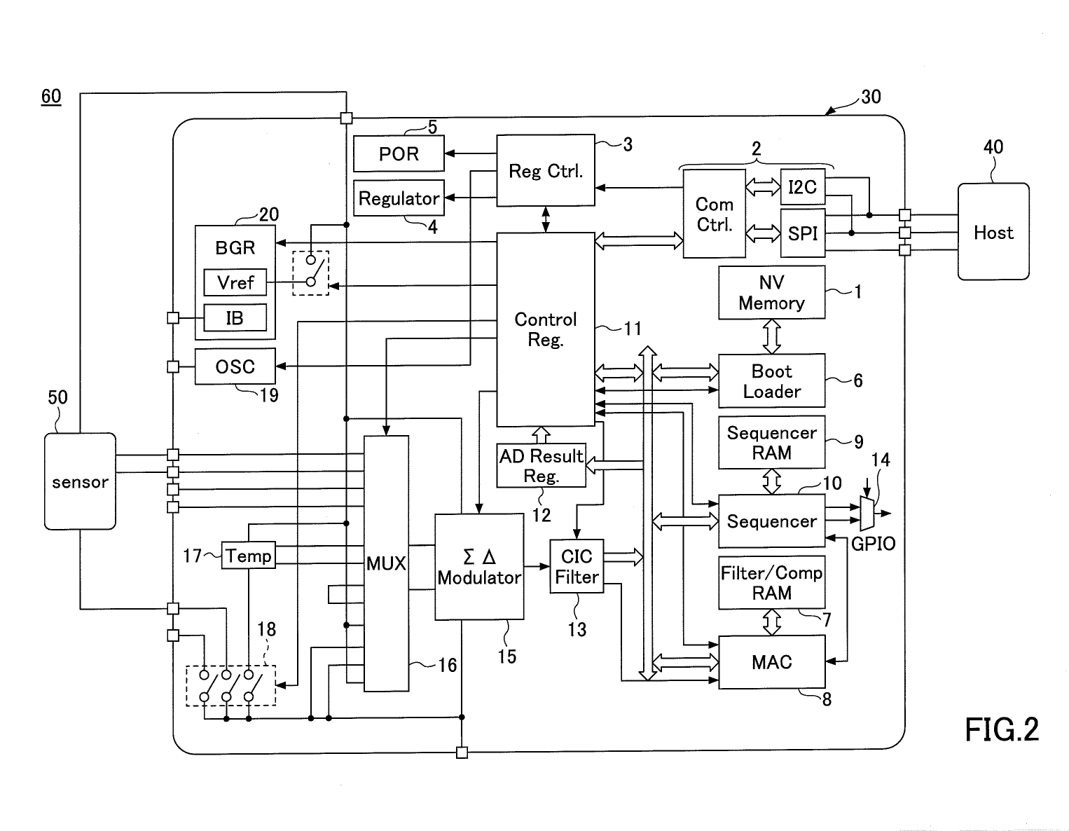

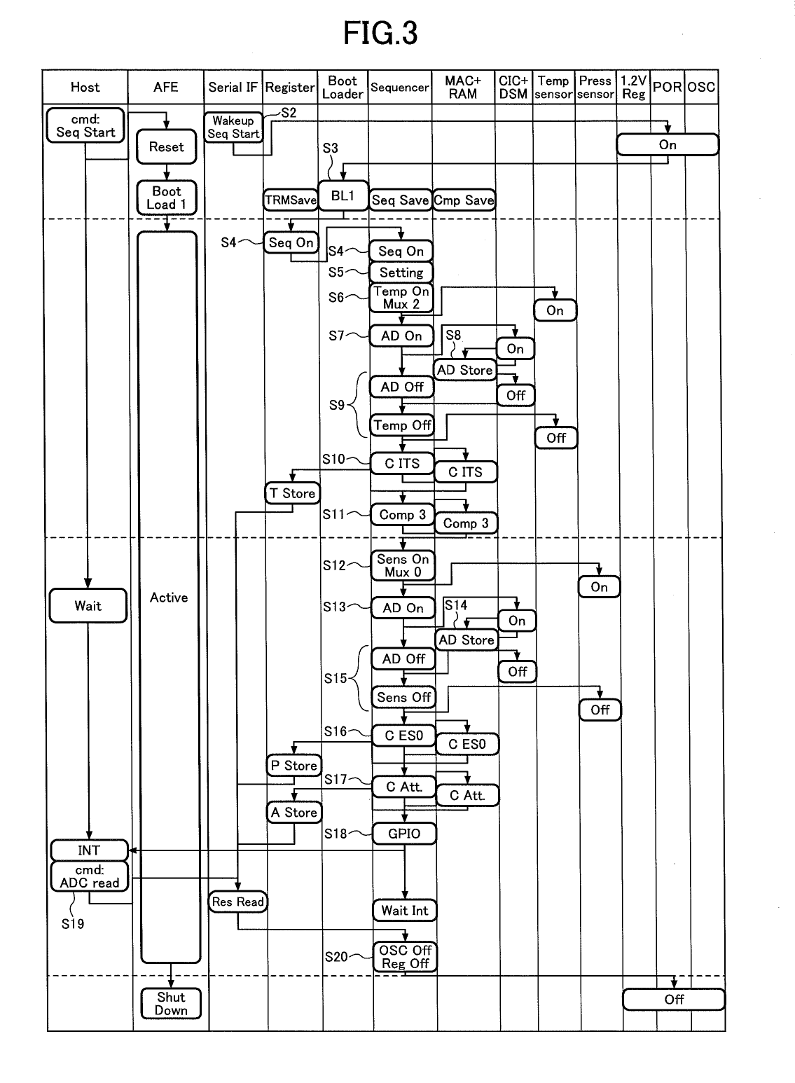

In the following, embodiments of the present invention will be described with reference to the accompanying drawings. FIG. 2 is a schematic diagram illustrating a configuration of a sensor output correction apparatus 60 according to an embodiment of the present invention. FIG. 3 is a sequence diagram illustrating processes (actions) of the sensor output correction apparatus 60. As illustrated in FIG. 2, the sensor output correction apparatus 60 is a sensor correction system including a sensor 50 and a sensor output correction circuit 30 that corrects sensor outputs supplied from the sensor 50. The sensor 50 detects predetermined a physical quantity and outputs a detection signal (as sensor output) in correspondence with the value of the detected physical quantity. The sensor 50 may be, for example, a pressure sensor, a temperature sensor, a voltage sensor, an electric current sensor, a distortion sensor, a magnetic sensor, a flow velocity sensor, and other sensors that detect physical quantity. Although an example of a configuration having a single sensor 50 connected to the sensor output correction circuit is illustrated in FIG. 2, one or more sensors may be connected to the sensor output correction circuit 30 for allowing the sensor output correction circuit 30 to correct sensor outputs of the one or more sensors.

The sensor output correction circuit 30 according to an embodiment of the present invention is a semiconductor integrated circuit having no microcomputer installed therein. The sensor output correction circuit 30 is divided into an analog circuit block part and a digital circuit block part. The analog circuit block part includes a band gap circuit 20, an oscillator 19, a power-on resetting circuit 5, a regulator 4, a temperature sensor 17, a switch 18, a multiplexer 16, and a ΔΣ modulator 15. The digital circuit block part includes a regulator controller 3, a control register 11, an access memory 12 (into which corrected values of the AD converted values of the sensor output are stored), a CIC (Cascaded Integrator Comb) filter 13, a communication interface circuit (communication IF) 2, a non-volatile memory 1, a boot loader 6, a sequence execution memory 9, a sequencer 10, a GPIO (General Purpose Input Output) 14, a correction operation memory 7, and an operation circuit 8 performing operations such as MAC (Multiply and Accumulation).

Next, an embodiment of a case where a pressure sensor is used as the sensor 50 is described.

### (Step S1)

Sensor characteristics of the sensor 50 are measured beforehand in an inspecting step.

Correction coefficients and analog trimming values corresponding to each of the measured sensor characteristics of the sensor 50 are stored beforehand in the non-volatile memory 1. Further, a predetermined sequencer program is also stored beforehand in the non-volatile memory 1. The non-volatile memory 1 is a storage unit capable of rewriting stored data in accordance with a rewriting device that is provided outside the sensor output correction circuit 30. The rewriting device may be, for example, the host device 40 or another device.

### (Step S2)

In a case where an AD conversion command from the host device 40 is received via the communication IF 2, the regulator controller 3 switches the regulator 4, the power-on resetting circuit 5, and the oscillator 19 to an enable state.

### (Step S3)

When the power-on resetting circuit 5 supplies a reset signal to the boot loader 6, the boot loader 6 reads (loads) a correction coefficient corresponding to a sensor characteristic from the non-volatile memory 1 and stores the correction coefficient to the correction operation memory 7. Then, the boot loader 6 reads the sequencer program from the non-volatile memory 1 and stores the sequencer program in the sequence execution memory 9. Further, the boot loader 6 reads the analog trimming values from the non-volatile memory 9 and adjusts each analog circuit block part with the analog trimming values by way of the control register 11. The boot loader 6 checks whether the values read from the non-volatile memory 1 is normal by performing a CRC (Cyclic Redundancy Check) operation on the read values. If the read values are normal, the boot loader 6 reports to the control register 11 that the boot loading process is completed (boot load completion report).

### (Step S4)

The control register 11 switches the sequencer 10 to an enable state upon receiving the boot load completion report from the boot loader 6. The enabled sequencer 10 reads a command included in the sequence program from the sequence execution memory 9 and executes a sequence corresponding to the command read from the sequence execution memory 9.

### (Step S5)

The sequencer 10 performs various settings on each block (e.g., setting an operation mode of the ΔΣ modulator 15, setting an oversampling ratio, setting a GPIO 14).

### (Step S6)

The sequencer 10 enables the temperature sensor 17 (i.e. switches the temperature sensor 17 to an enable state) by way of the switch 18 and switches the channel of the multiplexer 16 to the input of the temperature sensor 17.

### (Step S7)

The sequencer 10 enables the ΔΣ modulator 15 and the CIC filter 13.

### (Step S8)

The sequencer 10 waits for the output of the CIC filter 13 and stores the output of the CIC filter 13 in the correction operation memory 7.

### (Step S9)

The sequencer 10 disables the temperature sensor 17, the ΔΣ modulator 15, and the CIC filter 13.

### (Step S10)

The sequencer 10 reads the correction coefficient of the temperature sensor 17 and the output of the CIC filter 13 from the correction operation memory 7 and uses the correction coefficient of the temperature sensor 17 to correct the output of the CIC filter 13 by way of the operation circuit 8. Thereby, the sequencer 10 corrects the temperature value of the temperature sensor 17 (e.g., physical quantity in which its unit is expressed with Celsius (°C.)). The sequencer 10 stores the corrected temperature value in the correction operation memory 7 and the access memory 12 of the host device 40.

### (Step S11)

The sequencer 10 reads the temperature correction coefficient of the sensor 50 and the corrected temperature value from the correction operation memory 7, calculates the sensor correction coefficient of the sensor 50 (i.e. coefficient for correcting the sensor output of the sensor 50) by way of the operation circuit 8, and stores the calculated sensor correction coefficient in the correction operation memory 7.

### (Step S12)

The sequencer 10 enables the sensor 50 connected to a sensor connection port by way of the switch 18 and switches the channel of the multiplexer 16 to the input of the sensor 50.

### (Step S13)

The sequencer 10 enables the ΔΣ modulator 15 and the CIC filter 13.

### (Step S14)

The sequencer 10 waits for the output of the CIC filter 13 and stores the output of the CIC filter 13 in the correction operation memory 7.

### (Step S15)

The sequencer 10 disables the sensor 50, the ΔΣ modulator 15, and the CIC filter 13.

### (Step S16)

The sequencer 10 reads the sensor correction coefficient of the sensor 50 and the output value of the CIC filter 13 from the correction operation memory 7 and uses the sensor correction coefficient to correct the output value of the CIC filter 13 by way of the operation circuit 8. Thereby, the sequencer 10 corrects the pressure value of a pressure sensor (e.g., physical quantity in which its unit is expressed with Pa (pascal)). The sequencer 10 stores the corrected pressure value in the correction operation memory 7 and the access memory 12.

### (Step S17)

The sequencer 10 converts the corrected pressure value to an altitude value (e.g., physical quantity in which its unit is expressed with m (meters)) by way of the operation circuit 8 and stores the converted value in the correction operation memory 7 and the access memory 12.

### (Step S18)

The sequencer 10 reports completion of the AD conversion and the correction operation to the host device 40 via the GPIO 14.

### (Step S19)

The host device 40 reads the temperature value, the pressure value, and the altitude value stored in the access memory 12 via the communication IF 2.

### (Step S20)

When the host device 40 detects access to the access memory 12, the regulator controller 3 switches the regulator 4, the power-on resetting circuit 5, the oscillator 19, and the band gap circuit 20 to a standby state by disabling the regulator 4, the power-on resetting circuit 5, the oscillator 19, and the band gap circuit 20.

By repeating the above-described steps, the host device 40 can obtain the temperature value, the pressure value, and the altitude value in the form of physical quantities (values of sensor outputs from the sensor 50 and temperature sensor 17 whose units are converted).

Next, a configuration of the sequencer 10 is described in detail.

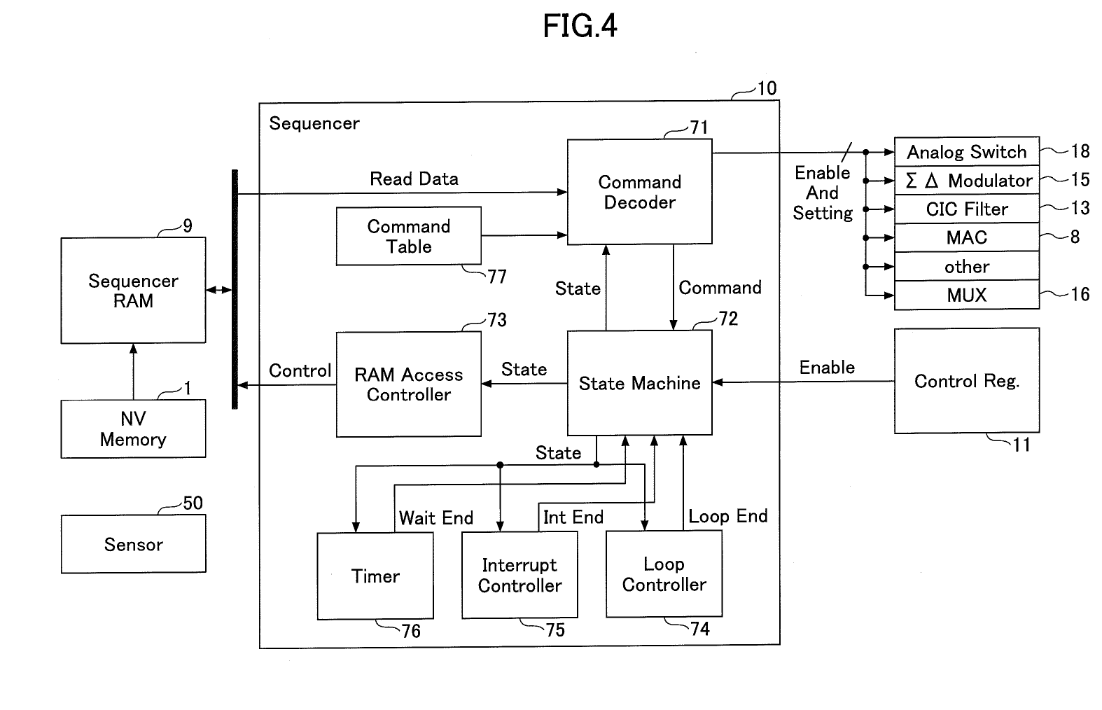

FIG. 4 is a schematic diagram illustrating a configuration of the sequencer 10 according to an embodiment of the present invention. The sequencer 10 is a sequence control circuit including a state machine 72. The state machine 72 is a sequence circuit that defines a subsequent state (subsequent status) according to a signal input to the state machine 72 and the current state (current status). The state machine 72 outputs a control signal corresponding to a state to circuits constituting the sequencer 10 other than the state machine 72 itself. For example, the state machine 72 may output the control signal to a memory controller (RAM access controller) 73, a command decoder 71, a loop controller 74, an interrupt controller 75, or a timer 76. Further, the sequencer 10 is activated by an enable signal supplied from the control register 11.

The non-volatile memory 1 is an auxiliary storage device that rewritably stores command data (i.e. data for instructing execution of multiple sequences) for correcting the sensor output supplied from the sensor 50. The command data that is stored in the non-volatile memory 1 beforehand is read out from the non-volatile memory 1 upon booting and stored in the sequence execution memory (main storage device) 9.

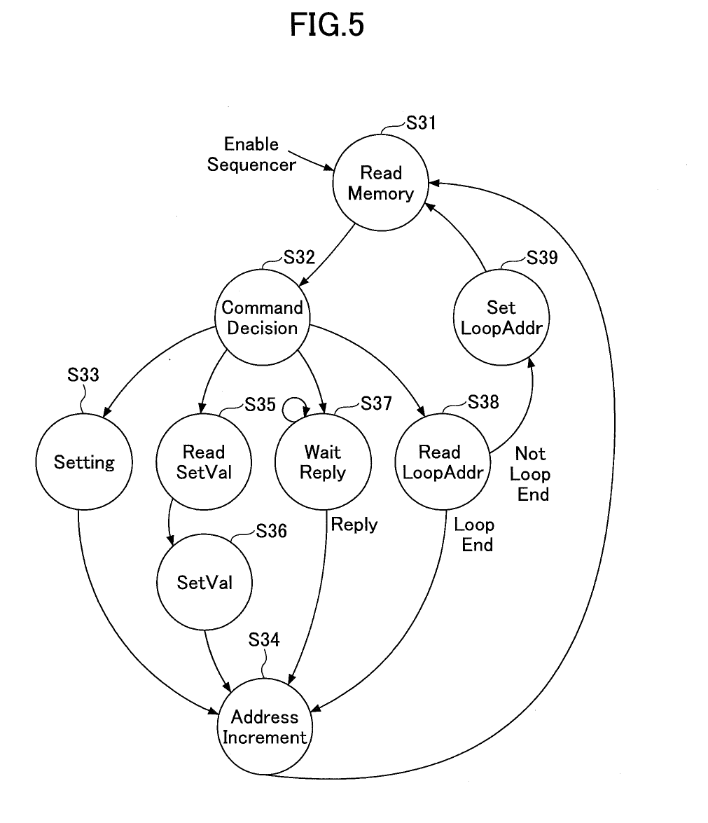

The memory controller 73 and the command decoder 71 are units that sequentially read command data in units of command data from the sequence execution memory 9 functioning as a work memory. Further, the command decoder 71 and the state machine 72 are units that analyze a command read from a command reading part and select an executing unit that executes a sequence corresponding to the analyzed command. The executing unit is selected from multiple sequence execution units provided in correspondence with each sequence. In the below-described example illustrated in FIG. 5, the state machine 72 includes an executing unit for executing a sequence in a Setting state S33, an executing unit for executing the sequences in a Read Set Value state S35 and a Set Value state S36, an executing unit for executing a sequence in a Wait Reply state S37, and an executing unit for executing the sequences in a Read Loop Address state S38 and a Set Loop Address state S39.

FIG. 5 is an example of a state chart of the sequencer 10. The state transition of FIG. 5 is described with reference to FIG. 4. The sequencer 10 operates in correspondence with a state of the state machine 72. In FIG. 5, the state of the state machine 72 is indicated as “S*” (“*” being an integer).

In a case where the sequencer 10 is enabled in response to an enable signal input to the state machine 72, the memory controller 73 reads command data from the sequence execution memory 9 in a Read Memory State S31. The initial address of the sequence execution memory 9 that is read by the memory controller 73 may be, for example, memory address 0. The command data that is stored in the sequence execution memory 9 is transferred from the non-volatile memory 1 upon booting.

In a Command Decision state S32, the command decoder 71 analyzes the content of the command read from the sequence execution memory 9 by comparing the read command with command data of a command table 77 that is prepared beforehand. The command table 77 is constituted by, for example, a logic circuit(s). By constituting the command table 77 with the logic circuit, the rate of analyzing the content of the command data can be increased. The command table 77 may be stored beforehand in a memory such as a ROM (Read Only Memory). The state machine 72 changes (selects) the destination of state transition (state transition destination) based on the result of the command comparison performed by the command decoder 71 in the Command Decision state S32.

TABLE 1

| | |
|---|---|
| cmd1 | ENABLE EXTERNAL SENSOR, SWITCH MULTIPLEXER TO |
| | CHANNEL 0 |
| cmd2 | SET CURRENT VALUE OF CONSTANT CURRENT OUTPUT |
| | CIRCUIT IN BANDGAP CIRCUIT TO A VALUE |
| | DESIGNATED IN NEXT MEMORY ADDRESS INCREMENT |
| | ADDRESS VALUE FROM 10 uA (01h) to 1280 uA (7Fh) IN |
| | UNITS OF 10 uA |
| cmd3 | EXECUTE CORRECTION OPERATION OF EXTERNAL |
| | SENSOR, CONVERT TO PHYSICAL QUANTITY. WAIT |
| | UNTIL COMPLETION OF CONVERSION |
| cmd4 | CONTINUE LOOP UNTIL INTERRUPTION FROM HOST |
| | DEVICE SET LOOP DESTINATION ADDRESS TO A VALUE |
| | DESIGNATED IN NEXT MEMORY ADDRESS |

Next, an example of the state transition destination is described. Table 1 illustrates examples of commands.

### Command Example 1

In a case where the command data read in the Command Decision state S32 is a command for enabling an external sensor of the sequencer 10 or a command for performing a predetermined setting (e.g., cmd1 in Table 1), the state machine 72 makes a transition to the Setting state S33. In the Setting state S33, the command decoder 71 outputs, for example, an enable signal for activating each external circuit. As illustrated in FIG. 4, the external circuit may be, for example, the switch 18, the ΔΣ modulator 15, the CIC filter 13, the operation circuit 8, and the multiplexer 16.

Then, in the Address Increment state S34, the memory controller 73 increments the memory address of the sequence execution memory 9 used when accessing the sequence execution memory 9 for executing a subsequent command. In this embodiment, the memory controller 73 increments (shifts) the memory address of the sequence execution memory 9 by incrementing (shifting) a predetermined address value from the current memory address of the sequence execution memory 9. Then, the state machine 31 makes a transition to the Read Memory state S31. Thereby, the operation of executing a series of commands by the sequencer 10 is completed.

### Command Example 2

In a case where the command data read in the Command Decision state S32 is a command for reading a setting value used in setting a predetermined circuit from the sequence execution memory 9 and setting the predetermined circuit with the setting value (e.g., cmd2 in Table 1), the state machine 31 makes a transition to a Read Setting Value Read state S35. In the Setting Value Read state S35, the memory controller 73 increments the memory address of the sequence execution memory 9 by incrementing a predetermined address value from the current memory address of the sequence execution memory 9 and reads a setting value from the sequence execution memory 9. In a Setting Value state S36, the command decoder 71 sets the predetermined circuit with the setting value read from the sequence execution memory 9.

Then, in the Address Increment state S34, the memory controller 73 increments the memory address of the sequence execution memory 9 used when accessing the sequence execution memory 9 for executing a subsequent command. In this embodiment, the memory controller 73 increments the memory address of the sequence execution memory 9 by incrementing a predetermined address value from the current memory address of the sequence execution memory 9. Then, the state machine 72 makes a transition to the Read Memory state S31. Thereby, the operation of executing a series of commands by the sequencer 10 is completed.

### Command Example 3

In a case where the command data read in the Command Decision state S32 is a command for performing operation execution, time waiting, interruption waiting, and enabling of a digital filter (e.g., cmd3 in Table 1), the state machine 31 makes a transition to a Wait Reply state S37. In the Wait Reply state S37, the command decoder 71 outputs enable signals to each predetermined circuit blocks and waits for an end signal or a trigger signal to be returned from each of the circuit blocks. When the end signal or the trigger signal is returned from each of the circuit blocks, the state machine 72 makes a transition to the Address Increment state S34.

Then, in the Address Increment state S34, the memory controller 73 increments the memory address of the sequence execution memory 9 used when accessing the sequence execution memory 9 for executing a subsequent command. In this embodiment, the memory controller 73 increments the memory address of the sequence execution memory 9 by incrementing a predetermined address value from the current memory address of the sequence execution memory 9. Then, the state machine 31 makes a transition to the Read Memory state S31. Thereby, the operation of executing a series of commands by the sequencer 10 is completed.

### Command Example 4

In a case where the command data read in the Command Decision state S32 is a command for performing a loop (e.g., cmd4 in Table 1), the state machine 72 makes a transition to a Loop Address Read state S38. In the Loop Address Read state S38, the memory controller 73 increments the memory address of the sequence execution memory 9 by incrementing a predetermined address value from the current memory address of the sequence execution memory 9 and reads an address of the loop destination from the sequence execution memory 9. In the Loop Address Setting state S39, the memory controller 73 changes the memory address of the sequence execution memory 9 to the loop destination address read in the Loop Address Read state S38. Then, the state machine 72 makes a transition to the Read Memory state S31 and the operation of executing a series of commands by the sequencer 10 is completed.

It is to be noted that, in the Loop Address Read state S38, the loop controller 74 determines whether the number of loops has reached a predetermined number of times, and the interrupt controller 75 determines whether any loop-end interruption is input. In a case where a loop ends, the state machine 72 makes a transition from the Loop Address Read state S38 to the address increment state S34.

Then, in the Address Increment state S34, the memory controller 73 increments the memory address of the sequence execution memory 9 used when accessing the sequence execution memory 9 for executing a subsequent command. In this embodiment, the memory controller 73 increments the memory address of the sequence execution memory 9 by incrementing a predetermined address value from the current memory address of the sequence execution memory 9. Then, the state machine 72 makes a transition to the Read Memory state S31. Thereby, the series of command executing processes (actions) performed by the sequencer 10 is completed.

Hence, as described above, the sequencer 10 reads data of one or more memory addresses from the sequence execution memory 9 with respect to a single command, so that a sequence corresponding the command can be executed. After execution of the sequence corresponding to a single command is completed, the state machine 72 is initialized by making a transition back to the Read Memory state S31 again with respect to a command other than a command for terminating the sequencer 10. Then, the sequencer 10 repeats execution of the next command(s) following the Read Memory state 31. Whenever execution of a sequence corresponding to a single command is completed, the memory address of the sequence execution memory 9 (to be accessed at the time of reading the next command) is shifted a predetermined value. Because a sequence(s) corresponding to a command is executed according to the address order in which data is stored in the sequence execution memory 9, the user can program the sequencer 10 by preparing commands beforehand and storing the commands in the sequence execution memory 9 in an order in which the user desires to have the commands executed.

For example, in a case where the sensor output correction apparatus 60 is a module that performs AD conversion once whenever the sensor output correction apparatus 60 activated, each command is stored in the sequence execution memory 9 in the following order.

| | |
|---|---|
| (Command cmd11) | Enable the sensor 50 |
| (Command cmd12) | Enable the ΔΣ modulator 15 and |
| | the digital filter 13 |
| (Command cmd13) | Wait for output of the digital |
| | filter 13 |
| (Command cmd14) | Disable the ΔΣ modulator 15 |
| | and the digital filter 13 |
| (Command cmd15) | Disable the sensor 50 |
| (Command cmd16) | Perform correction operation |
| | with the operation circuit 8 |
| (Command cmd17) | Output operation result to the |
| | host device 40 |

Thereby, the sequencer 10 can execute a sequence corresponding to the commands in the above order.

For example, in a case where the sensor output correction apparatus 60 is a module that performs AD conversion after the sensor output correction apparatus 60 is activated and continues to perform AD conversion until there is an interruption, each command is stored in the sequence execution memory 9 in the following order.

| | |
|---|---|
| (Command cmd21) | Enable the sensor 50 |
| (Command cmd22) | Enable the ΔΣ modulator 15 and |
| | The digital filter 13 |
| (Command cmd23) | Start loop |
| (Command cmd23-1) | Wait for output of the digital |
| | filter 13 |
| (Command cmd23-2) | Perform correction operation |
| | with the operation circuit 8 |
| (Command cmd23-3) | Output operation result to the |
| | host device 40 |
| (Command cmd24) | Determine whether to end loop |
| (Command cmd25) | Disable the ΔΣ modulator 15 |
| | and the digital filter 13 |
| (Command cmd26) | Disable the sensor 50 |

Thereby, the sequencer 10 can execute a sequence corresponding to the commands in the above order.

Accordingly, a given sequence program including multiple commands can be stored in the sequence execution memory 9 by combining the commands and arranging the order of the commands according to the usage/purpose of the sensor 50.

Hence, with the above-described embodiment, because a programmable sequencer 10 can be provided without having to install a MPU (Micro-Processing Unit), the host device 40 can be fabricated in a small scale but capable of converting sensor output values into physical quantity values at high speed. That is, sensor output values can be converted into physical quantity values without having to rely on the throughput (capacity) of the host device 40. Further, because the host device 40 can obtain the physical quantity detected by the sensor 50 with a minimal number of commands, the capacity of the host device 40 can be reduced. The power consumption of the overall system for performing sensor correction can be reduced because controls by the host device 40 and complication operations by the host device 40 can be reduced.

Further, because the sequence program has a format in which commands from the host device 40 are sequentially written, programming can be performed easily. Further, because a sequence program, which defines an action sequence of the sensor output correction apparatus 60, is stored beforehand in the non-volatile memory 1, a single type of sensor correction circuit 30 can be used to correct various kinds of sensors. Further, because the absolute values of sensor correction coefficients are stored in the non-volatile memory 1, a single type of sensor correction circuit 30 can be used to correct various kinds of sensors. Further, because the absolute values of sensor correction coefficients are stored in the non-volatile memory 1, inconsistencies among various kinds of sensors can be prevented.

Hence, with the above-described embodiment of the present invention, the workload of the host device can be reduced.

Further, the present invention is not limited to these embodiments, but variations and modifications may be made without departing from the scope of the present invention.

For example, in a case where a one-time ROM is used as the non-volatile memory 1, a sensor module that prohibits the user (e.g., user of the host device 24 side) from making changes can be obtained by using a circuit that prohibits (restricts) data to be written thereto. Further, in a case where the non-volatile memory 1 is rewritable, a different action sequence can be executed by changing the sequence program stored in the non-volatile memory 1.

Further, different sequence programs can be executed in accordance with control signals from the host device 14 by storing multiple sequence programs and multiple correction coefficients in the non-volatile memory 1. Further, multiple different kinds of sensors can be controlled and corrected by a single IC by connecting the multiplexer 16 to the multiple sensors.

Further, the sensor 50 is not limited to the pressure sensor or the temperature sensor. For example, other kinds of sensors such as an acceleration sensor may be used as the sensor 50. Further, AD converters other than the ΔΣ AD modulator 15 may also be used.

The present application is based on Japanese Priority Application No. 2012-003765 filed on Jan. 12, 2012, with the Japanese Patent Office, the entire contents of which are hereby incorporated by reference.

What is claimed is:

1. A sensor output correction circuit comprising:
a storage unit configured to rewritably store one or more commands for correcting a sensor output from a sensor;
a reading unit configured to read a target command from the one or more commands stored in the storage part;
a plurality of execution units, each of the plurality of execution units configured to execute a sequence corresponding to the one or more commands; and
a selecting unit configured to select a target execution unit from the plurality of execution units, the target execution unit configured to execute a target sequence corresponding to the target command read by the reading unit;
wherein when execution of the target sequence is completed, an address accessed by the reading unit at a time of reading the target command is shifted to another address.

2. The sensor output correction circuit as claimed in claim 2, wherein the selecting unit is configured to select the target execution unit by comparing the target command with command data of a command table.

3. The sensor output correction circuit as claimed in claim 1, wherein the command table is constituted by a logic circuit.

4. A sensor output correction apparatus comprising:
the sensor output correction circuit as claimed in claim 1; and
a sensor connected to the sensor output correction circuit.

5. A sequence control circuit comprising:
a reading unit configured to read a target command from one or more commands that are rewritably stored in a storage unit;
a plurality of execution units, each of the plurality of execution units configured to execute a sequence corresponding to the one or more commands; and
a selecting unit configured to select a target execution unit from the plurality of execution units, the target execution unit configured to execute a target sequence corresponding to the target command read by the reading part;
wherein when execution of the target sequence is completed, an address accessed by the reading part at a time of reading the target command is shifted to another address.

6. A sequence control method comprising the steps of:
reading a target command from one or more commands that are rewritably stored in a storage unit;
selecting a target execution unit from a plurality of execution units configured to execute a sequence corresponding to the one or more commands, the target execution unit configured to execute a target sequence corresponding to the target command read in the reading step;
wherein when execution of the target sequence is completed, an address accessed at a time of reading the target command in the reading step is shifted to another address.
